(19) United States
(12) Patent Application Publication
(10) Pub. No.: US 2012/0194905 A1
(43) Pub. Date: Aug. 2, 2012

(54) IMAGE DISPLAY APPARATUS AND IMAGE DISPLAY METHOD

(75) Inventors: Yoshijiro USHIO, Yokohama-shi (JP); Yutaka ICHIHARA, Yokohama-shi (JP)

(73) Assignee: NIKON CORPORATION, Tokyo (JP)

(21) Appl. No.: 13/441,921

(22) Filed: Apr. 9, 2012

Related U.S. Application Data
(63) Continuation of application No. PCT/JP2010/005701, filed on Sep. 17, 2010.

(30) Foreign Application Priority Data
Oct. 8, 2009 (JP) 2009-234646

(51) Int. Cl. G02B 27/22

(52) U.S. Cl. 359/464

(57) ABSTRACT

An image display apparatus for displaying plural sets of a pair of right-eye image and left-eye image to their corresponding viewing points is provided, which includes: a multi-view image generating unit which receives a right image and left image corresponding to predetermined two viewing points, and generates right-eye images and left-eye images corresponding to a plurality of viewing points by shifting the entireties of the received right image and left image; and a display unit which displays the right-eye images and left-eye images generated by the multi-view image generating unit to their corresponding viewing points.

The contents of the following Japanese patent application are incorporated herein by reference: No. 2009-234646 filed on Oct. 8, 2009. The contents of the following International patent application are incorporated herein by reference: No. PCT/JP2010/005701 filed on Sep. 17, 2010.

### BACKGROUND

1. Technical Field

The present invention relates to an image display apparatus and an image display method.

2. Related Art

There has conventionally been an apparatus that displays a three-dimensional image to a plurality of directions by using a lenticular sheet. There has also been known a technique for interpolating additional images by processing real images captured from different angles (see, for example, Patent Document 1).
Patent Document 1: Japanese Patent Application Publication No. H5-210181

However, when generating additional images for a plurality of viewing points by performing interpolation based on real images, a complex process is performed such as calculating a motion vector in each predetermined pixel area. Therefore, it takes a long time to generate an image for a plurality of viewing points. Particularly, image processing of each frame does not proceed in time when streaming a plurality of multi-view images such as a motion picture, etc.

### SUMMARY

Therefore, it is an object of an aspect of the innovations herein to provide an image display apparatus and an image display method, which are capable of overcoming the above drawbacks accompanying the related art. The above object can be achieved by combinations described in the claims. A first aspect of the innovations may provide an image display apparatus for displaying plural sets of a pair of right-eye image and left-eye image to their corresponding viewing points, which includes: a multi-view image generating unit which receives a right image and left image corresponding to predetermined two viewing points and generates right-eye images and left-eye images corresponding to a plurality of viewing points by shifting the entireties of the received right image and left image; and a display unit which displays the right-eye images and left-eye images generated by the multi-view image generating unit to their corresponding viewing points, and an image display method using the image display apparatus.

The summary clause does not necessarily describe all necessary features of the embodiments of the present invention. The present invention may also be a sub-combination of the features described above

### BRIEF DESCRIPTION OF THE DRAWINGS

FIG. 1 is a diagram showing an example configuration of an image display apparatus 100 according to an embodiment.

FIG. 2 is a diagram showing an example configuration of an image processing unit 10.

FIG. 3 is a diagram showing an example of a left image and a right image captured by an image capturing unit 12.

FIG. 4 is a diagram showing an example operation of a multi-view image generating unit 14.

FIG. 5 is a diagram showing an example operation of a display unit 50.

FIG. 6 is a diagram showing an example configuration of the display unit 50.

FIG. 7 is a diagram showing another example configuration of the image processing unit 10.

FIG. 8 is a diagram showing an example process by a left/right image generating unit 16.

FIG. 9 is a diagram showing an example configuration of the multi-view image generating unit 14.

FIG. 10 is a diagram showing another example configuration of the display unit 50.

FIG. 11 is a diagram showing another example configuration of the image processing unit 10.

FIG. 12 is a diagram showing another example configuration of the image processing unit 10.

### DESCRIPTION OF EXEMPLARY EMBODIMENTS

Hereinafter, an embodiment of the present invention will be described. The embodiment does not limit the invention according to the claims, and all the combinations of the features described in the embodiment are not necessarily essential to means provided by aspects of the invention.

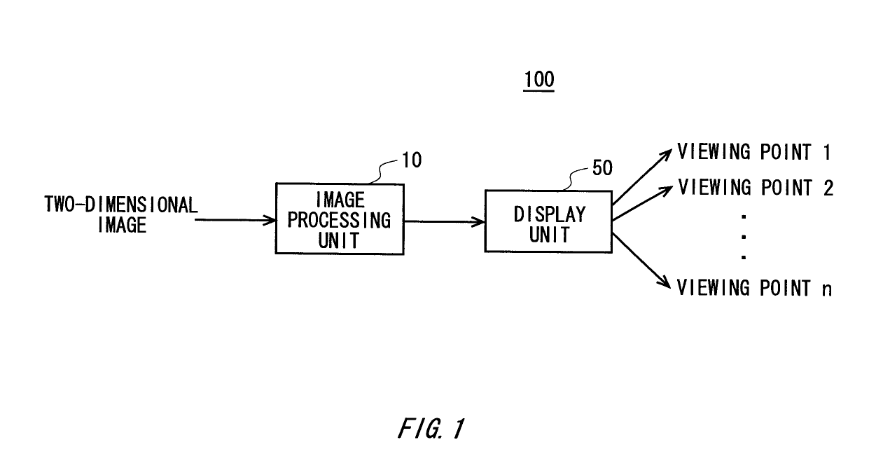

FIG. 1 is a diagram showing an example configuration of an image display apparatus 100 according to an embodiment. The image display apparatus 100 displays plural sets of a pair of right image and left image to their corresponding viewing points 1 to n. One viewing point corresponds to, for example, the position of the right eye or the left eye of a user. That is, the image display apparatus 100 displays a pair of right image and left image to adjoining two viewing points. The image display apparatus 100 generates a right image or a left image corresponding to a respective viewing point from a supplied two-dimensional image.

The image display apparatus 100 according to the present embodiment includes an image processing unit 10 and a display unit 50. The image processing unit 10 acquires a two-dimensional image. The image processing unit 10 may acquire one two-dimensional image corresponding to one viewing point, or may acquire two two-dimensional images corresponding to two viewing points. In the latter case, the two two-dimensional images may be stereo images of a subject shot from two positions corresponding to both eyes of a human being.

The image processing unit 10 generates “n” images corresponding to “n” viewing points (“n” being an even number equal to or greater than 4, for example) from an acquired two-dimensional image. For example, the image processing unit 10 generates n/2 right-eye images and n/2 left-eye images. Here, a right-eye image may be an image to be displayed to the right eye of a user, and a left-eye image may be an image to be displayed to the left eye of the user.

The display unit 50 displays the “n” images generated by the image processing unit 10 to “n” viewing points. For example, the display unit 50 displays the “n” images to “n” viewing points based on a lenticular system or a parallax barrier system. The display unit 50 according to the present embodiment displays a three-dimensional image to multiple viewing points by displaying corresponding right-eye image and left-eye image to adjoining viewing points.

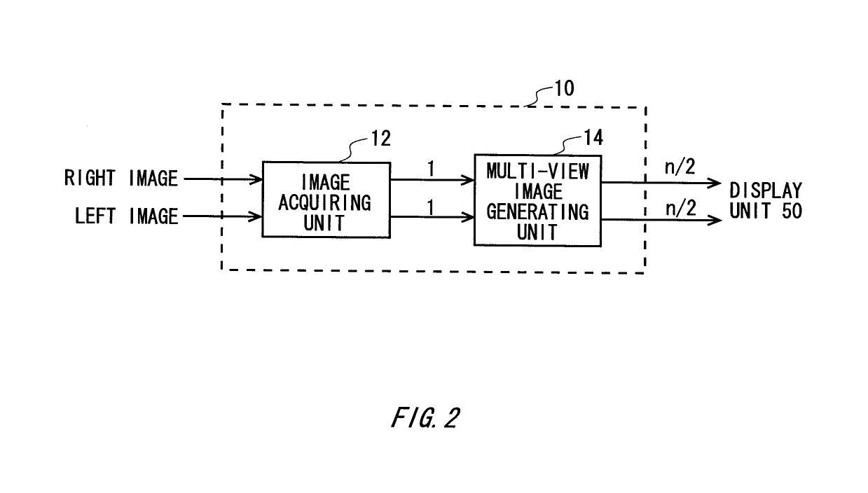

FIG. 2 is a diagram showing an example configuration of the image processing unit 10. The image processing unit 10 according to the present example acquires a right image and a left image corresponding to predetermined two viewing points. Predetermined two viewing points may be viewing points corresponding to the right eye and the left eye of a user. That is, the right image and left image may be the stereo images described above.

The image processing unit 10 according to the present example includes an image acquiring unit 12 and a multi-view image generating unit 14. The image acquiring unit 12 acquires a right image and a left image corresponding to predetermined two viewing points. The image acquiring unit 12 may acquire a right image and a left image from an external device, or may acquire a right image and a left image by shooting a subject from different two positions.

The multi-view image generating unit 14 receives the right image and left image corresponding to the predetermined two viewing points from the image acquiring unit 12, and generates right-eye images and left-eye images corresponding to viewing points different from the predetermined two viewing points by shifting the entireties of the received right image and left image respectively. That is, the display unit 50 displays a three-dimensional image reflecting the subject at different positions for different viewing points. This allows for displaying a three-dimensional image corresponding to each viewing point.

The multi-view image generating unit 14 according to the present example supplies the display unit 50 with right-eye and left-eye images for “n” viewing points together with the right image and left image received from the image acquiring unit 12. More specifically, the multi-view image generating unit 14 supplies the display unit 50 with right-eye images for n/2 viewing points and left-eye images for n/2 viewing points. The display unit 50 receives the right image and left image acquired by the image acquiring unit 12 and the images generated by the multi-view image generating unit 14, and displays them to their corresponding viewing points. The display unit 50 may display the images in parallel.

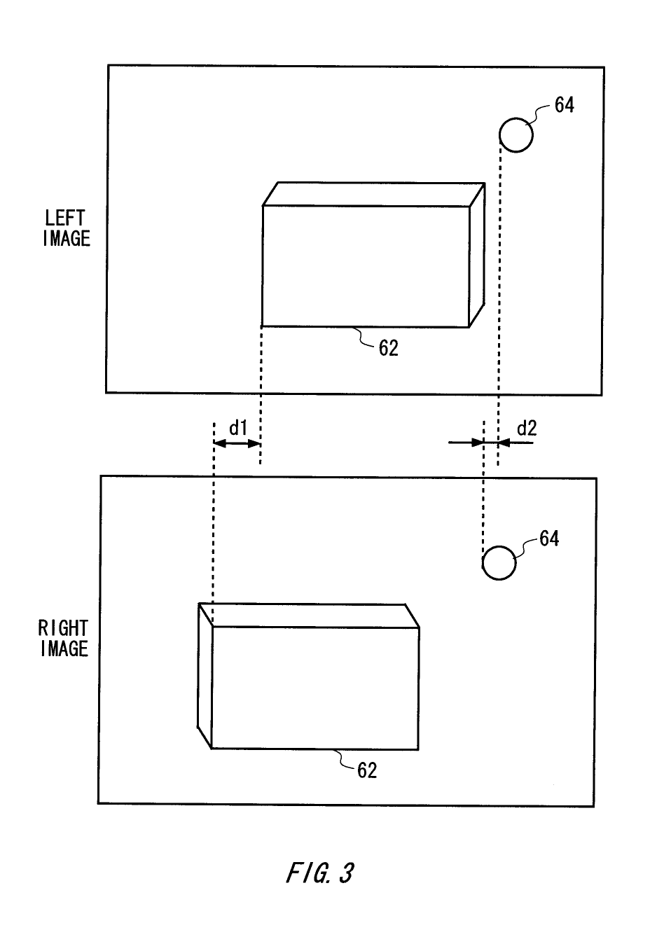

FIG. 3 is a diagram showing an example of a left image and a right image acquired by the image acquiring unit 12. The left image and right image according to the present example are stereo images of the same subject shot from different two positions corresponding to both eyes of a human being. The subject in the left image and that in the right image have a parallax corresponding to the distance from the image shooting device to the subject. In FIG. 3, the parallax of a subject 62 between the left and right images is d1, and the parallax of a subject 64 between the left and right images is d2.

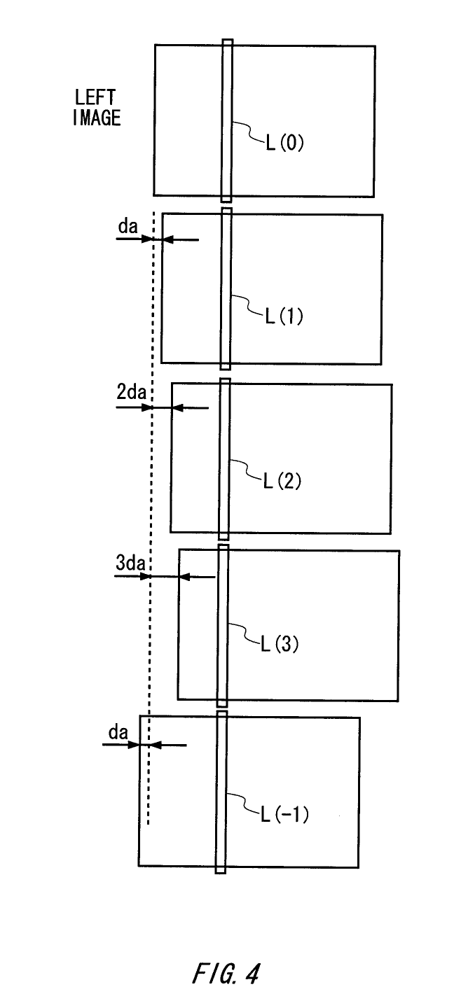

FIG. 4 is a diagram showing an example operation of the multi-view image generating unit 14. FIG. 4 describes a case of generating n/2 left-eye images based on the left image received from the image acquiring unit 12. The operation is the same for when generating n/2 right-eye images based on the right image received from the image acquiring unit 12.

The multi-view image generating unit 14 generates n/2 left-eye images by shifting the entirety of the received left image by a predetermined shift amount respectively. For example, the multi-view image generating unit 14 generates a plurality of rightward-shifted left-eye images obtained by shifting the entirety of the received left image in the right direction by a shift amount da respectively, and a plurality of leftward-shifted left-eye images obtained by shifting it in the left direction by the shift amount da respectively.

FIG. 4 shows an example of generating seven left-eye images, with the number of viewing points n=14. In this case, the multi-view image generating unit 14 may generate three rightward-shifted left-eye images and three leftward-shifted left-eye images in addition to the original left image, as shown in FIG. 4. The multi-view image generating unit 14 may generate six rightward-shifted left-eye images or six leftward-shifted left-eye images in addition to the original left image.

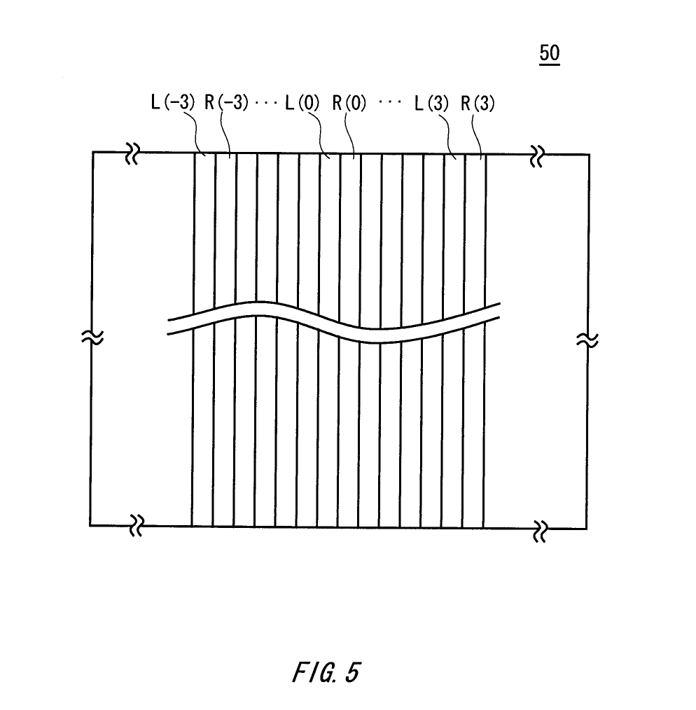

FIG. 5 is a diagram showing an example operation of the display unit 50. The display unit 50 according to the present example displays the plurality of right-eye images and the plurality of left-eye images generated by the multi-view image generating unit 14 in the same frame in parallel. For example, the display unit 50 extracts from the plurality of left-eye images obtained by shifting the entirety of the original left image in the x-axial direction respectively, pixel columns at the same x-axial position (in the present example, L(−3) to L(3)), as shown in FIG. 4. Likewise, the display unit 50 extracts from the plurality of right-eye images obtained by shifting the entirety of the original right image in the x-axial direction respectively, pixel columns at the same x-axial position (in the present example, R(−3) to R(3)). The pixel columns may include one pixel or a plurality of pixels within their width in the x-axial direction.

The display unit 50 displays the regions of the plurality of left-eye images and right-eye images that are at the same x-axial position in a region of a display plane that corresponds to that x-axial position in a predetermined arrangement. For example, the display unit 50 displays each predetermined number of pixel columns among the pixel columns of the plurality of left-eye images and among the pixel columns of the plurality of right-eye images alternately. In the example of FIG. 5, the display unit 50 displays each one pixel column among the pixel columns of the left-eye images and among the pixel columns of the right-eye images alternately. Likewise, in any other region of the display plane, the display unit 50 displays the regions of the plurality of right-eye images and left-eye images that correspond to that region in the predetermined arrangement.

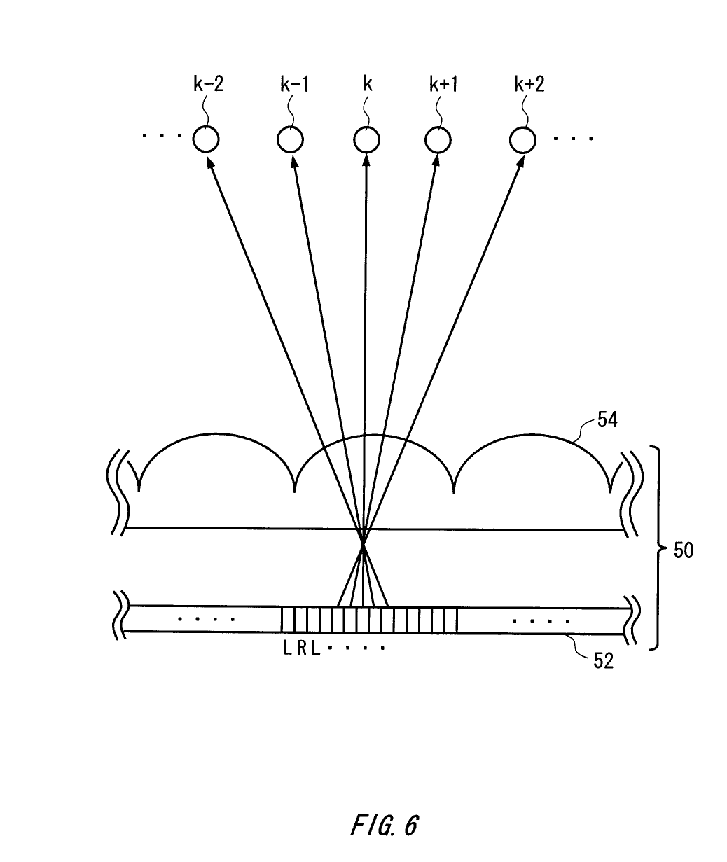

FIG. 6 is a diagram showing an example configuration of the display unit 50. The display unit 50 of the present example includes a lens array 54 and a display element 52. The display element 52 displays the pixel columns of the plurality of left-eye images and right-eye images in the predetermined arrangement as described in relation with FIG. 5. The lens array 54 includes a plurality of lenses arranged in a predetermined pattern. The lens array 54 may be a lenticular lens array that includes a plurality of semicircular-column-shaped lenses arranged at a predetermined pitch in the x-axial direction.

Each lens of the lens array 54 is provided for a predetermined number of pixel columns that corresponds to the number of viewing points. For example, when the number of viewing points “n” is 14 as in FIG. 4 and FIG. 5, each lens is provided for fourteen pixel columns of the display plane of the display element 52. Each lens displays the pixel columns to their corresponding viewing points (in the present example, viewing points 1, 2, . . . , k−2, k−1, k, k+1, k+2, . . . , 13, 14).

The above configuration enables multi-view left-eye images and right-eye images to be generated easily from a pair of right image and left image supplied. Further, it enables the generated multi-view left-eye images and right-eye images to be displayed to their corresponding viewing points. The display unit 50 described according to the present example is of a lenticular system. However, the display unit 50 may be of a parallax barrier system.

It is preferred that the multi-view image generating unit 14 generate shifted images for the respective viewing points such that the largest value of the shift amounts between the images generated from the right image acquired by the image acquiring unit 12 and the largest value of the shift amounts between the images generated from the left image acquired by the image acquiring unit 12 are smaller than the largest parallax amount between the right image and the left image. For example, to describe this by using the example of FIG. 3 and FIG. 4, the multi-view image generating unit 14 sets the unit shift amount da such that the shift amount 6da between the leftmost left-eye image and the rightmost left-eye image is sufficiently smaller than the largest parallax amount d1. Likewise, the multi-view image generating unit 14 sets the unit shift amount da such that the largest shift amount 6da for the right-eye images is sufficiently smaller than the largest parallax amount d1. In the present example, the unit shift amount da for the right-eye images and that for the left-eye images are equal.

In the example described above, the multi-view image generating unit 14 generates left-eye images and right-eye images that are shifted from the original left image and right image respectively by the uniform amount da. In another example, the multi-view image generating unit 14 may generate left-eye images and right-eye images that are shifted from the original images by non-uniform shift amounts respectively. For example, the multi-view image generating unit 14 may set a relatively small shift amount between adjoining left-eye images and adjoining right-eye images if they are such left-eye images and right-eye images that correspond to viewing points near the center among the plurality of viewing points, and may set a relatively large shift amount between adjoining left-eye images and adjoining right-eye images if they are such left-eye images and right-eye images that correspond to viewing points near the ends. In this case, when the viewing point of a user changes near the center of the plurality of viewing points, it is possible to switch the images smoothly because the difference between the images to be displayed is small.

Alternatively, the multi-view image generating unit 14 may set a relatively large shift amount between adjoining left-eye images and adjoining right-eye images if they are such left-eye images and right-eye images that correspond to viewing points near the center, and may set a relatively small shift amount between adjoining left-eye images and adjoining right-eye images if they are such left-eye images and right-eye images that correspond to viewing points near the ends. In this case, when the viewing point of a user changes near an end of the plurality of viewing points, it is possible to switch the images smoothly.

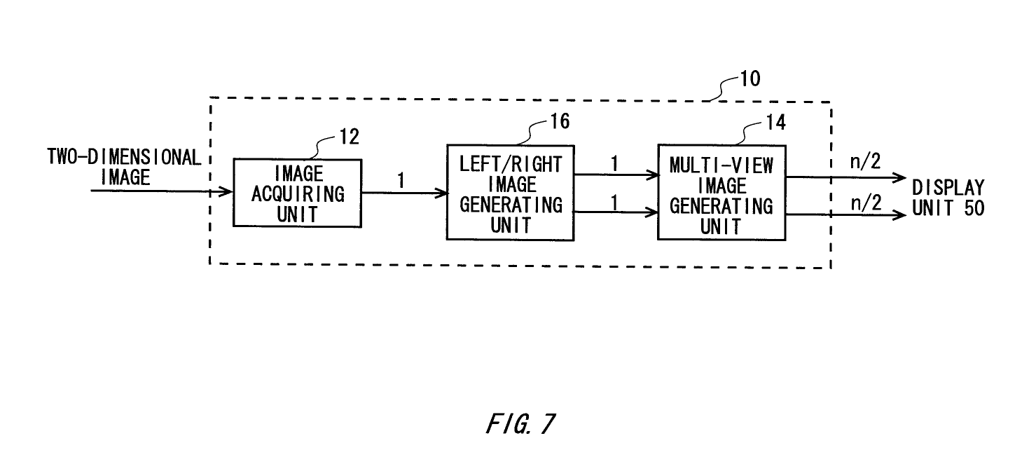

FIG. 7 is a diagram showing another example configuration of the image processing unit 10. The image processing unit 10 according to the present example includes an image acquiring unit 12, a left/right image generating unit 16, and a multi-view image generating unit 14. The image acquiring unit 12 acquires one two-dimensional image. The image acquiring unit 12 may acquire a two-dimensional image from an external device or may acquire a two-dimensional image by shooting a subject.

The left/right image generating unit 16 generates a right image and a left image for adjoining two viewing points among a plurality of viewing points by shifting the entirety of the two-dimensional image acquired by the image acquiring unit 12, and inputs the generated images into the multi-view image generating unit 14. The left/right image generating unit 16 may shift the entirety of the two-dimensional image by an eye distance shift amount corresponding to the distance between both eyes of a human being. For example, the left/right image generating unit 16 may generate a right image and a left image by shifting the entirety of the two-dimensional image such that the shift amount between the right image and left image to be generated becomes an eye distance shift amount of approximately 6.5 cm.

The multi-view image generating unit 14 generates n/2 right-eye images and n/2 left-eye images based on the right image and left image received from the left/right image generating unit 16. The multi-view image generating unit 14 may generate a plurality of right-eye images and left-eye images according to the same process as that of the multi-view image generating unit 14 described in relation with FIG. 2. This configuration allows for easily generating left-eye images and right-eye images for multiple viewing points from one two-dimensional image.

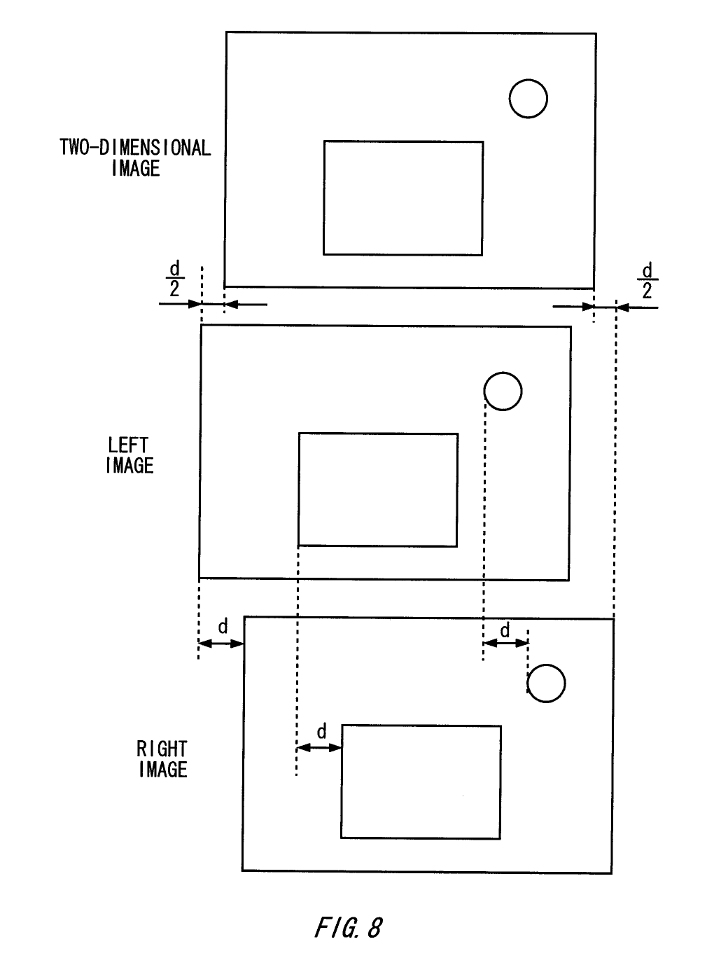

FIG. 8 is a diagram showing an example process by the left/right image generating unit 16. The left/right image generating unit 16 generates based on the received two-dimensional image, a left image and a right image of which entireties are shifted with respect to each other in the x-axial direction by a predetermined eye distance shift amount d. By selectively displaying the left image and right image to the left eye and right eye of a user, it is possible to provide a three-dimensional image that seems like each subject is present at the infinity.

It is preferred that the multi-view image generating unit 14 generate right-eye images and left-eye images for the respective viewing points such that the largest value of the shift amounts between left-eye images to be generated from the left image and the largest value of the shift amounts between right-eye images to be generated from the right image are sufficiently smaller than the eye distance shift amount d of the left/right image generating unit 16. Like the multi-view image generating unit 14 described in relation with FIG. 2, the multi-view image generating unit 14 may generate left-eye images and right-eye images shifted from the left and right images respectively by non-uniform shift amounts.

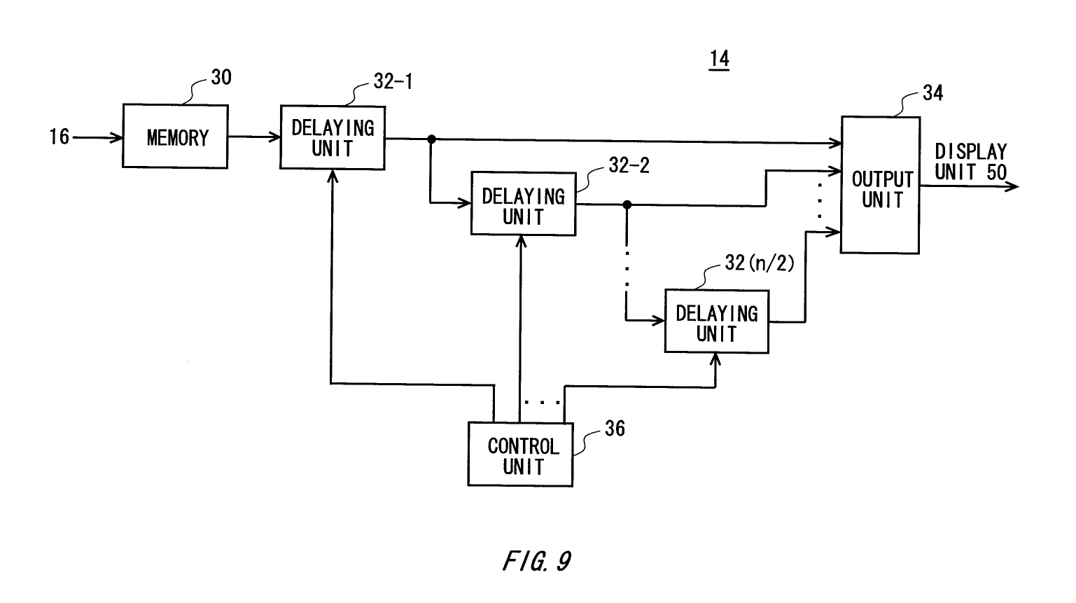

FIG. 9 is a diagram showing an example configuration of the multi-view image generating unit 14. The multi-view image generating unit 14 according to the present example includes a memory 30, a plurality of delaying units 32, an output unit 34, and a control unit 36. FIG. 9 will describe components of the multi-view image generating unit 14 that are for processing either a left image or a right image. However, the multi-view image generating unit 14 further includes the same components as in FIG. 9 for processing the other of a left image and a right image.

The memory 30 stores a right image or a left image, and outputs data on a pixel column basis from a pixel column at an end in order. A pixel column is a column of pixels arranged along a direction orthogonal to the x-axial direction described above. A number of delaying units 32 that corresponds to the number of viewing points (in the present example, n/2) are provided in cascade connection. That is, the plurality of delaying units 32 correspond to n/2 left-eye images or right-eye images that are to be output from the multi-view image generating unit 14 for the left image or the right image.

The control unit 36 sets delay amounts for the respective delaying units 32 in accordance with the shift amounts of their corresponding left-eye images or right-eye images. For example, the control unit 36 sets a time taken to read out 10 pixel columns from the memory 30 as a delay time of such a delaying unit 32 that corresponds to a left-eye image or a right-eye image of which shift amount from its preceding left-eye image or right-eye image is 10 pixel columns. The control unit 36 may set a uniform delay amount for a uniform shift amount or may set non-uniform delay amounts for non-uniform shift amounts.

The output unit 34 receives in parallel, pixel column data output by the plurality of delaying units 32. As described above, since each delaying unit 32 delays data from the memory 30 by a delay amount corresponding to the shift amount, the output unit 34 receives in parallel, data of pixel columns of which positions in the image are shifted in the x-axial direction, such as the pixel columns L(3), L(2), . . . shown in FIG. 4.

The output unit 34 supplies the display unit 50 with synthesized data of the pixel column data received in parallel, which are arranged in a predetermined order. Since the display unit 50 displays an image for multiple viewing points on one screen, an image for one viewing point includes less pixel columns than those included in the original image as being thinned out. The output unit 34 may generate thinned-out data including less pixel columns in accordance with the number of viewing points, by generating a piece of synthesized data in each period in which such a number of pixel columns as corresponding to the number of viewing points are read out from the memory 30 and supplying the synthesized data to the display unit 50.

Such a configuration allows for easily displaying on the display unit 50, a plurality of thinned-out left-eye images and right-eye images including less pixel columns in accordance with the number of viewing points. Further, such a configuration allows the shift amounts for left-eye images and right-eye images to be adjusted easily.

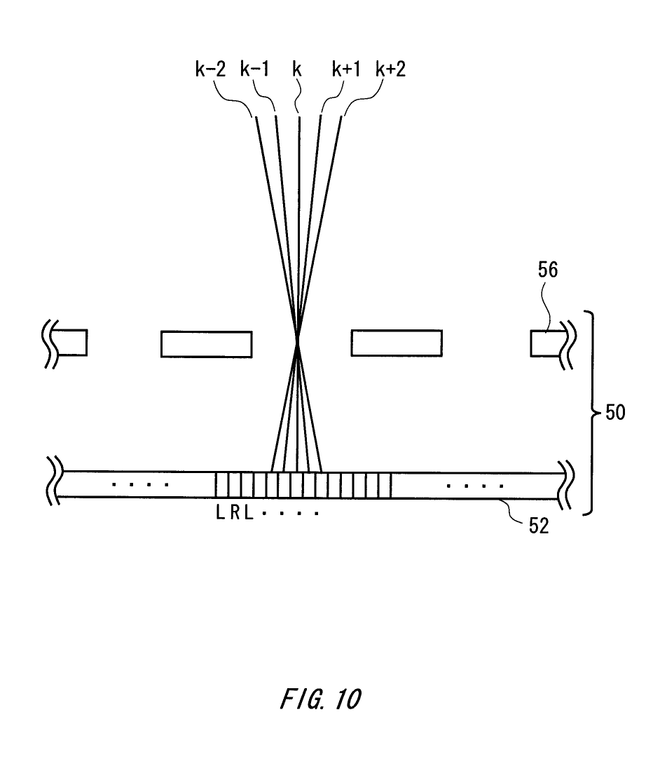

FIG. 10 is a diagram showing another example configuration of the display unit 50. The display unit 50 according to the present example includes a display element 52 and a barrier unit 56. In the barrier unit 56, transmission portions for allowing light transmission and shielding portions for shielding light are arranged in a predetermined arrangement pattern. It is preferred that the barrier unit 56 include shutter elements for controlling whether or not to allow light to transmit therethrough in a matrix arrangement, and be able to change the arrangement pattern by controlling each shutter element as to whether or not to let it allow light to transmit therethrough. The barrier unit 56 may comprise a liquid crystal panel.

The display element 52 may be the same as the display element 52 described in relation with FIG. 6. The display element 52 displays to the barrier unit 56, such a region of each shifted image as corresponding to the arrangement pattern of transmission portions and shielding portions of the barrier unit 56. The barrier unit 56 may include in a region facing the display element 52, strip-shaped transmission portions and shielding portions which each have a predetermined width and which are arranged alternately from the upper end to the lower end of the display element 52. In this case, the display element 52 extracts from each shifted image, a strip-shaped pixel column which has a width obtained by dividing the width of the transmission portions of the barrier unit 56 by the number of viewing points, and displays the pixel columns of the respective shifted images in a predetermined arrangement order.

The display element 52 may change the pattern of the regions to be extracted from the respective left-eye images and right-eye images in accordance with a change of the arrangement pattern of the transmission portions and shielding portions of the barrier unit 56. For example, when the width of the strip-shaped transmission portions of the barrier unit 56 is changed, the display element 52 adjusts the width of the pixel columns to be extracted from the respective left-eye images and right-eye images in accordance with the width of the transmission portions after changed.

The transmission portions and shielding portions of the barrier unit 56 may be arranged in various arrangement patterns. The transmission portions and shielding portions of the barrier unit 56 may be provided obliquely from the upper end to the lower end of the display element 52, or may be provided from the right end to the left end of the display element 52. The transmission portions and shielding portions of the barrier unit 56 may be provided in a staggered arrangement. That is, the transmission portions and shielding portions of the barrier unit 56 may be provided alternately both in the vertical direction and horizontal direction of the display element 52. The display element 52 may define the shape of the regions to be extracted from the respective left-eye images and right-eye images in accordance with the arrangement pattern of the transmission portions and shielding portions of the barrier unit 56.

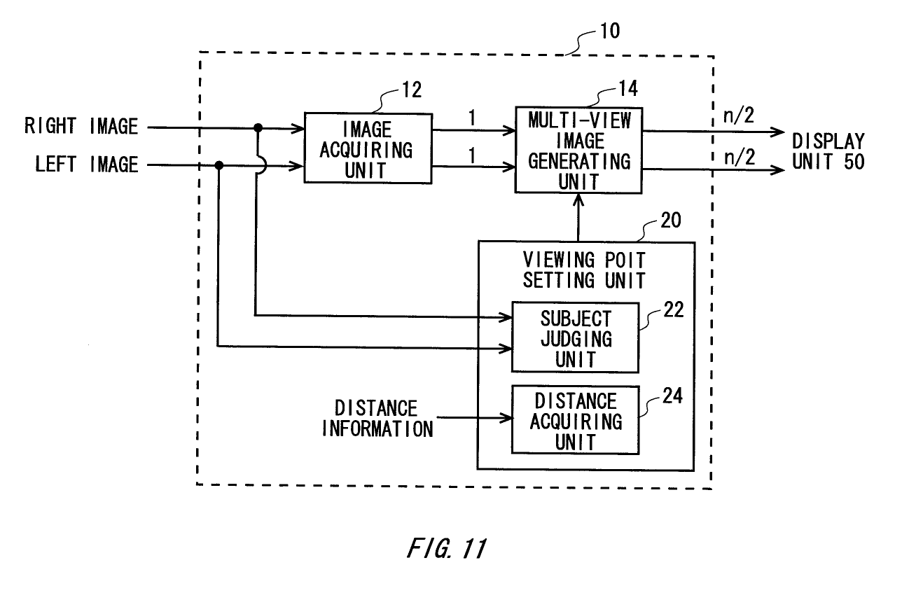

FIG. 11 is a diagram showing another example configuration of the image processing unit 10. The image processing unit 10 according to the present example further includes a viewing point setting unit 20 in addition to the components of any of the image processing units 10 described in relation with FIG. 1 to FIG. 10. FIG. 11 describes the configuration of the image processing unit 10 described in relation with FIG. 2, to which a viewing point setting unit 20 is added.

The viewing point setting unit 20 sets a viewing point number “n” to the multi-view image generating unit 14. The viewing point setting unit 20 may set a viewing point number “n” to the multi-view image generating unit 14 in accordance with the viewing point number set by a user, etc. The multi-view image generating unit 14 generates shifted images corresponding to respective viewing points in accordance with the set viewing point number “n”. The multi-view image generating unit 14 may change the shift amount for left-eye images and right-eye images in accordance with the set viewing point number “n”. For example, the multi-view image generating unit 14 calculates the shift amount for the respective left-eye images and right-eye images by dividing a preset total shift amount by a number corresponding to a set viewing point number.

The viewing point setting unit 20 may include a subject judging unit 22 which sets a viewing point number to the multi-view image generating unit 14 based on a subject included in an image to be acquired by the image acquiring unit 12. When a subject of which image is desired to be displayed at a higher resolution is included in the image, the subject judging unit 22 may set a relatively small viewing point number to the multi-view image generating unit 14. More specifically, when the spatial frequency of a subject included in an image acquired by the image acquiring unit 12 is higher, the subject judging unit 22 may set a smaller viewing point number to the multi-view image generating unit 14.

The viewing point setting unit 20 may include a distance acquiring unit 24 which acquires distance information of a subject included in an image acquired by the image acquiring unit 12, and sets a viewing point number to the multi-view image generating unit 14 in accordance with the acquired distance information. The distance acquiring unit 24 may acquire data of shooting conditions that is affixed to the image. When the image acquiring unit 12 acquires stereo right and left images, the distance acquiring unit 24 may acquire distance information of a subject based on the amount of parallax between the subject included in the right image and that included in the left image.

When the subject is at a closer distance, the distance acquiring unit 24 may set a larger viewing point number to the multi-view image generating unit 14. Furthermore, the viewing point setting unit 20 may set a viewing point number to the multi-view image generating unit 14 based on the combination of the subject judging unit 22 and the distance acquiring unit 24.

The multi-view image generating unit 14 may vary the shift amount of the left-eye images and right-eye images from their adjoining left-eye images and right-eye images based on the position of a user. For example, the multi-view image generating unit 14 sets a smaller shift amount for left-eye images and right-eye images corresponding to viewing points closer to the position of the user. This realizes smooth image motion at the viewing points close to the position of the user. The image processing unit 10 may further include a position detecting unit which detects the position of a user and notifies it to the multi-view image generating unit 14. The position detecting unit includes an imaging device such as a CCD element, etc.

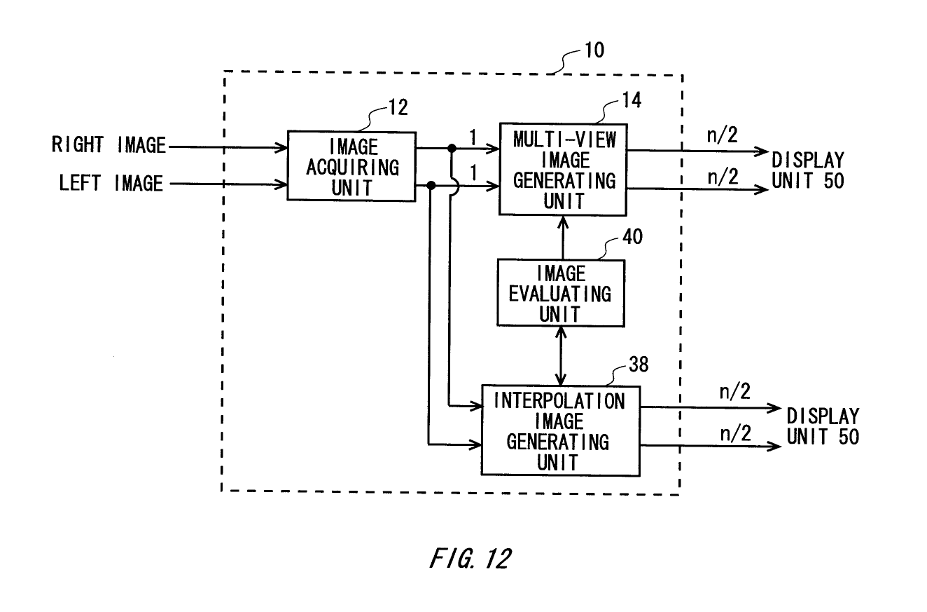

FIG. 12 is a diagram showing another example configuration of the image processing unit 10. The image processing unit 10 according to the present example further includes an image evaluating unit 40 and an interpolation image generating unit 38 in addition to the components of any of the image processing units 10 described in relation with FIG. 1 to FIG. 11. FIG. 12 shows the configuration of the image processing unit 10 described in relation with FIG. 2, to which the image evaluating unit 40 and the interpolation image generating unit 38 are added. The other components may be the same as those of any of the image processing units 10 described in relation with FIG. 1 to FIG. 11.

The interpolation image generating unit 38 generates right-eye images and left-eye images for a plurality of viewing points independently from the multi-view image generating unit 14, based on a relationship between corresponding points in right and left images supplied to the multi-view image generating unit 14. The interpolation image generating unit 38 may calculate a motion vector between corresponding points in the right and left images, or may calculate a parallax between them. The interpolation image generating unit 38 calculates a motion vector or parallax which an image for each viewing point should have from the right image or left image, by performing interpolation based on the position of each viewing point. The interpolation includes a process for interpolating a value for a viewing point that is between two viewing points based on the values for the two viewing points, and a process for extrapolating a value for a viewing point that is not between two viewing points based on the values for the two viewing points.

For example, the interpolation image generating unit 38 calculates an interpolation vector or interpolation parallax which is obtained by multiplying a motion vector or parallax between the right image and the left image by a ratio between a difference between the positions of the viewing points of the right image and left image and a difference between the position of the viewing point of the right image and the position of another viewing point. Then, the interpolation image generating unit 38 generates an image which has the interpolation vector or interpolation parallax from the right image, as the image for the “another” viewing point. Likewise, by generating interpolation vectors or interpolation parallaxes for the respective viewing points, the interpolation image generating unit 38 can generate images for the plurality of viewing points from the supplied right image and left image.

The image evaluating unit 40 evaluates right-eye images and left-eye images generated by the interpolation image generating unit 38. The evaluation here is for evaluating whether or not it is possible to provide an appropriate three-dimensional image based on the right-eye images and left-eye images. The image evaluating unit 40 may perform the evaluation based on the right image and left image supplied to the interpolation image generating unit 38, or may perform the evaluation based on the right-eye images and left-eye images generated by the interpolation image generating unit 38, or may perform the evaluation based on any parameter that is detected during the image processing by the interpolation image generating unit 38.

For example, the interpolation image generating unit 38 detects plural sets of corresponding points in the supplied right image and left image at which the same subject is imaged, and estimates a motion vector or parallax for the entire images from the motion vector or parallax between each set of corresponding points. Hence, the more sets of corresponding points the interpolation image generating unit 38 detects, the more accurately it can estimate the motion vector or parallax of the entire images.

The interpolation image generating unit 38 may detect corresponding points by comparing edge components, etc. in the right image and left image. Hence, it is not necessarily possible to detect a sufficient number of sets of corresponding points. The image estimating unit 40 may judge the right-eye images and left-eye images generated by the interpolation image generating unit 38 as not being able to provide an appropriate three-dimensional image, when the number of sets of corresponding points detected by the interpolation image generating unit 38 is equal to or smaller than a predetermined value.

Further, the more evenly the sets of corresponding points detected by the interpolation image generating unit 38 are distributed over the entire images, the more accurately it can estimate the motion vector or parallax of the entire images. The image evaluating unit 40 may evaluate the right-eye images and left-eye images generated by the interpolation image generating unit 38 based on the distribution of the sets of corresponding points detected by the interpolation image generating unit 38. For example, when the largest value among the distances between the respective sets of corresponding points is equal to or larger than a predetermined value, the image evaluating unit 40 evaluates the right-eye images and left-eye images generated by the interpolation image generating unit 38 as not being able to provide an appropriate three-dimensional image.

When the evaluation result of the image evaluating unit 40 is equal to or lower than a predetermined level, the display unit 50 displays the right-eye images and left-eye images generated by the multi-view image generating unit 14. When the evaluation result of the image evaluating unit 40 is higher than the level, the display unit 50 displays the right-eye images and left-eye images generated by the interpolation image generating unit 38. For example, the display unit 50 displays the right-eye images and left-eye images generated by the multi-value image generating unit 14 when the right-eye images and left-eye images generated by the interpolation image generating unit 38 are evaluated as not being able to provide an appropriate three-dimensional image.

The multi-view image generating unit 14 and the interpolation image generating unit 38 may generate images in parallel. Alternatively, in another example operation, the multi-view image generating unit 14 may generate right-eye images and left-eye images when the evaluation result of the image evaluating unit 40 is equal to or lower than the level. That is, when the right-eye images and left-eye images generated by the interpolation image generating unit 38 are evaluated as being able to provide an appropriate three-dimensional image, the multi-view image generating unit 14 needs not generate any right-eye images or left-eye images.

Moreover, the interpolation image generating unit 38 needs not generate any right-eye images or left-eye images when the evaluation based on the number or the distribution of sets of corresponding points in the right image and left image is equal to or lower than the predetermined level. In this case, the multi-value image generating unit 14 supplies the display unit 50 with right-eye images and left-eye images for the plurality of viewing points as described above. The image evaluating unit 40 may control whether to let the multi-view image generating unit 14 and the interpolation image generating unit 38 generate right-eye images and left-eye images.

The image evaluating unit 40 may evaluate the right-eye images and left-eye images by comparing the largest value of the parallaxes between plural sets of a pair of right-eye image and left-eye image generated by the interpolation image generating unit 38 with a predetermined value. The largest value of the parallaxes is obtained by calculating for each pair of corresponding right-eye and left-eye images, parallaxes between the respective sets of corresponding points in the corresponding right-eye and left-eye images, and finding the largest value of all the parallaxes calculated in this way. When the largest value of the parallaxes is equal to or larger than the predetermined value, the image evaluating unit 40 may evaluate the right-eye images and left-eye images as not being able to provide an appropriate three-dimensional image. The image evaluating unit 40 may receive information regarding a result of evaluation performed by a user.

The image acquiring unit 12 described in relation with FIG. 1 and FIG. 12 may acquire a moving image including a plurality of images. In this case, the image processing unit 10 generates a plurality of left-eye images and right-eye images for each frame of the moving image by the process described in relation with FIG. 1 and FIG. 12. Even when a moving image is streaming-distributed, the image processing unit 10 can timely generate a plurality of left-eye images and right-eye images in the respective frames of the moving image because it can generate a plurality of left-eye images and right-eye images by a simple process.

The multi-view image generating unit 14 described in relation with FIG. 1 to FIG. 12 generates left-eye images and right-eye images by using the same shift amount(s) for the left image and the right image. In another example, the multi-view image generating unit 14 may generate left-eye images and right-eye images by using different shift amounts for the left image and the right image. That is, the multi-view image generating unit 14 may use different shift amounts for any corresponding left-eye image and right-eye image with respect to another corresponding left-eye image and right-eye image depending on the position of a viewing point. This allows for displaying an image that gives different depth feels to different viewing points.

While the embodiment of the present invention has been described, the technical scope of the invention is not limited to the above described embodiment. It is apparent to persons skilled in the art that various alterations and improvements can be added to the above-described embodiment. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

What is claimed is:

1. An image display apparatus that displays plural sets of a pair of right-eye image and left-eye image to their corresponding viewing points, comprising:
a multi-view image generating unit which receives a right image and left image corresponding to predetermined two viewing points, and generates the right-eye images and left-eye images corresponding to a plurality of viewing points by shifting entireties of the received right image and left image; and
a display unit which displays the right-eye images and left-eye images generated by the multi-view image generating unit to their corresponding viewing points.

2. The image display apparatus according to claim 1,
wherein the multi-view image generating unit receives two-dimensional images shot from different positions as the right image and left image corresponding to the predetermined two viewing points.

3. The image display apparatus according to claim 2,
wherein the multi-view image generating unit generates the right-eye images and left-eye images such that a largest value of shift amounts of the right-eye images, and a largest value of shift amounts of the left-eye images are smaller than a largest parallax amount between the right image and left image corresponding to the predetermined two viewing points.

4. The image display apparatus according to claim 1, further comprising
a left/right image generating unit which generates the right image and left image corresponding to the predetermined two viewing points by shifting an entirety of a supplied two-dimensional image, and inputs the generated right image and left image into the multi-view image generating unit.

5. The image display apparatus according to claim 4, wherein
the left/right image generating unit generates the right image and left image that correspond to adjoining two viewing points among a plurality of viewing points by shifting the entirety of the two-dimensional image by a predetermined eye distance shift amount, and
the multi-view image generating unit generates the right-eye images and left-eye images such that a largest value of shift amounts of the right-eye images, and a largest value of shift amounts of the left-eye images are smaller than the eye distance shift amount.

6. The image display apparatus according to claim 1, wherein
the multi-view image generating unit generates the right-eye images and left-eye images which are obtained by respectively shifting the entireties of the right image and left image corresponding to the predetermined two viewing points by non-uniform shift amounts.

7. The image display apparatus according to claim 6, wherein
the multi-view image generating unit varies a shift amount of the right-eye images and left-eye images based on a position of a user.

8. The image display apparatus according to claim 1, wherein
the display unit includes:
a barrier unit in which transmission portions for allowing light transmission and shielding portions for shielding light are arranged in a predetermined arrangement pattern; and
a display element which displays to the barrier unit, such regions of the respective right-eye images and left-eye images as corresponding to the arrangement pattern.

9. The image display apparatus according to claim 8, wherein
the barrier unit includes shutter elements for controlling whether or not to allow light to transmit therethrough in a matrix arrangement, and is able to change the arrangement pattern by controlling each shutter element as to whether or not to let it allow light to transmit therethrough, and
the display element changes shapes of the regions of the respective right-eye images and left-eye images that are to be displayed in accordance with a change of the arrangement pattern.

10. The image display apparatus according to claim 1, wherein
the multi-view image generating unit generates the right-eye images and left-eye images for viewing points in accordance with a viewing point number to be set.

11. The image display apparatus according to claim 10, further comprising
a subject judging unit which sets the viewing point number to the multi-view image generating unit based on a subject included in an image.

12. The image display apparatus according to claim 10, further comprising
a distance acquiring unit which acquires distance information of a subject included in an image, and sets the viewing point number to the multi-view image generating unit in accordance with the acquired distance information of the subject.

13. The image display apparatus according to claim 1, further comprising:
an interpolation image generating unit which generates the right-eye images and left-eye images corresponding to the plurality of viewing points independently from the multi-view image generating unit, based on a relationship between corresponding points in the right image and left image; and
an image evaluating unit which evaluates the right-eye images and left-eye images generated by the interpolation image generating unit,
wherein the display unit displays the right-eye images and left-eye images generated by the multi-view image generating unit when an evaluation result of the image evaluating unit is equal to or lower than a predetermined level.

14. The image display apparatus according to claim 13, wherein
the multi-view image generating unit generates the right-eye images and left-eye images when the evaluation result of the image evaluating unit is equal to or lower than the predetermined level.

15. The image display apparatus according to claim 13, wherein
the interpolation image generating unit detects plural sets of corresponding points in the right image and left image at which a same subject is imaged, and generates the right-eye images and left-eye images corresponding to the plurality of viewing points based on the respective sets of corresponding points, and
the image evaluating unit evaluates the right-eye images and left-eye images generated by the interpolation image generating unit based on a number of sets of the corresponding points detected by the interpolation image generating unit.

16. The image display apparatus according to claim 13, wherein
the interpolation image generating unit detects plural sets of corresponding points in the right image and left image at which a same subject is imaged, and generates the right-eye images and left-eye images corresponding to the plurality of viewing points based on the respective sets of corresponding points, and
the image evaluating unit evaluates the right-eye images and left-eye images generated by the interpolation image generating unit based on distribution of the plural sets of corresponding points detected by the interpolation image generating unit.

17. The image display apparatus according to claim 15, wherein
the interpolation image generating unit does not generate the right-eye images and left-eye images when an evaluation result of the image evaluating unit is equal to or lower than the predetermined level.

18. The image display apparatus according to claim 13, wherein
the image evaluating unit evaluates the right-eye images and left-eye images generated by the interpolation image generating unit by comparing a largest value of parallaxes between the plural sets of a pair of right-eye image and left-eye image generated by the interpolation image generating unit with a predetermined value.

19. An image display method for displaying plural sets of a pair of right-eye image and left-eye image to their corresponding viewing points, comprising:
generating the right-eye images and left-eye images corresponding to a plurality of viewing points by receiving a right image and left image corresponding to predetermined two viewing points and shifting entireties of the received right image and left image; and
displaying the right-eye images and left-eye images generated in the step of generating the right-eye images and left-eye images to their corresponding viewing points.
